(19) United States
(12) Patent Application Publication
(10) Pub. No.: US 2024/0191869 A1
(43) Pub. Date: Jun. 13, 2024

(54) DEVICE FOR STEAM GENERATION AND WATER-BEARING DOMESTIC APPLIANCE WITH SUCH A DEVICE

(71) Applicant: E.G.O. Elektro-Geraetebau GmbH, Oberderdingen (DE)

(72) Inventors: Tobias Albert, Kraichtal (DE); Volker Block, Bretten (DE); Dominik Debelt, Bruchsal (DE); Sebastian Eigl, Bretten (DE); Uwe Koegel, Kuernbach (DE); Thomas Krapp, Oestringen-Odenheim (DE); Michael Tafferner, Malsch (DE)

(21) Appl. No.: 18/520,838

(22) Filed: Nov. 28, 2023

(30) Foreign Application Priority Data
Dec. 9, 2022 (DE) 10 2022 213 368.4

(51) Int. Cl. F22B 1/28; A47J 27/04; H05B 3/06

(52) U.S. Cl. CPC F22B 1/28; A47J 27/04; H05B 3/06; A21B 3/04

(57) ABSTRACT

A device for steam generation has a device housing, a heating chamber for water with a water inlet for connection to a water supply and a steam outlet. A heating element is provided on the heating chamber for heating up and evaporating water therein and has a metallic heating element carrier and heating conductors arranged thereon, preferably as thick-film heating conductors. The heating chamber and the heating element are arranged in the device housing. The heating element forms a wall of the heating chamber and is connected in sealing manner to other walls of the heating chamber. The heating chamber is in one extension direction longer than it is wide and deep in both extension directions vertical thereto. An electrical connection device for the device is provided laterally on an elongated side of the heating chamber on the device housing, in particular projecting laterally from the device housing in order to achieve a flat design.

### CROSS-REFERENCE TO RELATED APPLICATIONS

This application claims priority to German Application No. 10 2022 213 368.4, filed Dec. 9, 2022, the contents of which are hereby incorporated herein in its entirety by reference.

### AREA OF APPLICATION AND PRIOR ART

The invention relates to a device for steam generation, which is also known as a steam generator, and to a water-bearing domestic appliance with such a device for steam generation, which is also known as a steam cooker, steamer or steam oven. The device for steam generation has a device housing with heating chamber and heating element therein, wherein a water inlet leads into the heating chamber and a steam outlet leads out.

Such devices are known, for example from DE 102018217645 A1 or EP 1975517 A1. Each of them are designed to heat up and evaporate a certain quantity of water in a tank. The steam generated is then passed into a treatment chamber or into a muffle of the said domestic appliance, for example to prepare food using steam, and hence more healthily.

### OBJECT AND SOLUTION

The object underlying the invention is to create a device for steam generation as mentioned at the outset and a water-bearing domestic appliance provided therewith, using which problems of the prior art can be solved and with which it is in particular possible to design the device for steam generation simply and dependably, and to readily integrate it into a domestic appliance.

This object is solved by a device for steam generation having the features of claim 1, and by a water-bearing domestic appliance provided with such a device and having the features of claim 23. Advantageous and preferred embodiments of the invention are the subject matter of further claims and are explained in greater detail in the following. Some of the features are described only for the device for steam generation or only for the domestic appliance provided therewith. They are however intended to apply, by themselves and independently of one another, both for such a device and for a domestic appliance provided therewith. The wording of the claims is incorporated by express reference into the content of the description.

The device for steam generation has a device housing and therein a heating chamber for water that has a water inlet for connection to a water supply, for example to a water tank or water pipe. The heating chamber also has a steam outlet, which passes steam by means of a hose or pipe into a treatment chamber of a water-bearing domestic appliance or steam oven. A heating element is arranged/provided at the heating chamber for heating up and evaporating water in the heating chamber. The heating element has a heating element carrier and heating conductors arranged thereon. Advantageously, the heating element may be designed as a thick-film heating element with thick-film heating conductors. The heating chamber and the heating element are arranged in the device housing, wherein the heating element preferably forms only one part of the heating chamber. In accordance with the invention, the heating element forms a wall of the heating chamber or only a single wall, wherein it is connected in sealing manner to other walls of the heating chamber, preferably by pressing plus sealing. The heating element thus jointly forms, with these other walls, the heating chamber, closed per se, which thus has the water inlet and the steam outlet as its only openings. The heating element carrier consists of metal, wherein the other walls of the heating chamber and the device housing preferably consist of plastic, permitting easy manufacture.

The heating chamber is longer than it is wide in one extension direction, said extension direction being the vertical direction after installation into the domestic appliance. The heating chamber has even less depth in the extension direction vertical to the length and width. Advantageously, that applies not only for the heating chamber, but also for the entire device and its device housing. An electrical connection device for the device, and in particular for the heating element, is provided laterally on the device housing on an elongated side of the heating chamber, in particular projecting laterally from the device housing. It is achieved with this lateral arrangement of the connection device that it increases at least the previously mentioned depth. It is thus possible, during installation into a domestic appliance in accordance with the invention, that the depth increases slightly due to the depth of the device housing, without the connection device contributing to that.

In an embodiment of the invention, the connection device may be designed as a plug connection device, wherein it may have plug connection lugs and/or plug connection sockets. These may be connected to the heating element electrically and/or structurally or mechanically, thereby achieving contacting, advantageously by laying or pressing them into contact. This may either be permanent or be achieved only by laying or pressing them into contact. Alternatively, screw connections may also be provided.

In an advantageous embodiment of the invention, electrical contacting of the connection device to the heating element or to the heating conductor may be provided on the side of the heating element facing away from the heating chamber, which is advantageously a dry side of the heating element. The side of the heating element facing the heating chamber forms a wall of the heating chamber and is thus at least partially covered with water or steam. An electrical contacting may have contact fields that are connected to the heating conductors. Flexibly designed contact arms of the connection device may be pressed onto the contact fields, thereby achieving the contacting. These contact arms extend preferably parallel to one another and next to one another, and their distance apart may be a few millimeters. The contact arms may be identical. Alternatively, they may have various thicknesses or widths, depending on the current or electric power to be transmitted.

In a preferred embodiment of the invention, the heating chamber is flat, as is the device housing, wherein the electrical connection device protrudes from a narrow side of the flat device housing. This has already been touched upon previously.

In a further embodiment of the invention, the heating element may be curved in a channel shape away from the heating chamber such that a crest line of the curvature extends along the extension direction over the length of the device. Due to this curvature, the heating element can be designed sturdy, and curves or expands in a predetermined direction when heated. Furthermore, it is possible with a predetermined width of the device housing to slightly enlarge the heated surface due to the curvature. It may be provided here that the curvature of the heating element corresponds to or makes up between 5% and 20% of the width of the heating element. The heating element may preferably have a rectangular shape in the plan view, which is a shape easy to manufacture. This also makes it possible to form a plurality of individual heating elements easily and efficiently from a predetermined blank. The curvature may have uniform rounding, so that the heating element can be part of a tube as the blank. The heating element may be a casing section of 5% to 20% of an entire tube or, depending on the required or accepted curvature, 5 to 20 heating elements can be cut from one round tube.

In an embodiment of the invention, the device housing may have an elongated trough for the heating chamber, into which the water inlet and the steam outlet discharge. This trough may have a consistent cross-section or consistent curvature. Advantageously, the trough has lateral trough walls and an all-round trough rim thereon. The heating element may be in sealing contact with this all-round trough rim such that the trough and the heating element form the heating chamber and completely enclose it. Since the heating chamber should advantageously be flat, as set forth above, the water inlet and/or the steam outlet discharge into the heating chamber at the short flat sides. One of the advantages of this is that they thus do not cover or take up any surface on which the heating element is advantageously arranged. This element can thus have the largest possible area.

In an advantageous development of the invention, a groove with a seal therein may extend around the trough rim, wherein the heating element is in all-round contact with said seal, advantageously with sufficient pressure, thus effecting the sealing function. This seal should, due to the expected temperatures of the heating element, be temperature-resistant, so that it may advantageously consist of silicone or EPDM. It may be placed into the said groove as a separately manufactured seal, wherein it may be designed as a round-cord seal or be adapted to the specific shape of the groove. Alternatively, the seal may be injected onto the trough rim, which simplifies fitting of the device. For the plastic of the trough itself, PPS is a suitable plastic material, as it can durably sustain temperatures of around 160° C., and at peaks even temperatures of over 200° C.

Advantageously, the device housing has a housing upper part which is fastened to the trough, which preferably forms a housing lower part, such that the housing upper part presses the heating element against the trough or against the aforementioned seal. The housing upper part may have an all-round pressure rib or projection that is opposite the trough rim or seal or that extends outside the trough rim over the aforementioned seal. Such a pressure rib or projection may extend preferably all the way around, such that it presses the heating element all the way around against the trough rim extending all the way around or against the seal. This assures not only the mechanical cohesion of the device housing or device, but also and above all tightness of the heating chamber, so that neither water nor steam can leak out.

In a further embodiment of the invention, the trough or a said housing upper part may have at the side, outside the all-round trough rim, supporting projections or stops with which the heating element is in contact with a lateral rim, in particular with the lateral rims at the end of the curvature. This allows the position of the heating element in the device and on the trough to be secured, which is important for a precise and easy to manufacture connection.

In a development of the invention, a housing upper part is advantageously detachably fastened to the trough, wherein in particular a snap connection or a clip connection are provided to do so. A fastening running all round the heating chamber may be advantageously provided here. This is also particularly advantageously provided at or close to the end areas of the heating chamber near to the water inlet/steam outlet.

In an embodiment of the invention, the electrical connection device is designed with a connection housing on a housing upper part, wherein in particular the connection housing is shaped or injected onto it in one piece. The connection housing should if possible not project above the device housing in the thickness direction, so that the device does not become thicker due to the electrical connection device or the connection housing.

In an embodiment of the invention, the connection housing may be open on or towards at least one side, wherein plug units can be inserted into the connection housing from this side and are then detachably fastenable therein. They can be fastenable therein in particular by means of an engaging device, i.e. snapped in. The plug units are in electrical contact with the heating element, advantageously by means of the previously described contact arms. The plug units may be in particular plastic housings, in which plug connection lugs or plug connection sockets can be arranged. Alternatively, the plug units may be held as plug connection lugs or plug connection sockets in a holding part consisting of plastic. The plug connection lugs or plug connection sockets may be provided with contact arms, for example cast on, fastened or welded, that protrude in the insertion direction. The holding part may be designed insertable into the connection housing, wherein it can then be detachably fastened therein. It may be fastenable by means of an engagement device.

In a further embodiment of the invention, the housing upper part may extend at a short distance over the heating element, wherein the distance may be between 1 mm and 20 mm. The housing upper part may have ventilation openings for ventilating or cooling the heating element, as is known per se. The housing upper part may, in the area above the heating element, be designed largely in honeycomb form with webs and honeycomb-like interstices between them. This permits good ventilation, and sufficient stability is also achieved.

In an embodiment of the invention, a knitted fabric made of thin material may be arranged in the heating chamber, in particular made from or including wire or plastic threads. This may be arranged at least in an area close to the steam outlet and/or water inlet. It allows limescale in the heating chamber to be reduced. Furthermore, excessive bubbling in the heating chamber can be avoided when the water is boiling inside it.

A water-bearing domestic appliance in accordance with the invention, which in particular is designed as a steam baking oven or as a steam cooker, has an appliance housing and a treatment chamber for preparing cooked food by means of steam, preferably by means of hot steam. A previously described device for steam generation is arranged outside the treatment chamber and in particular behind it, inside the appliance housing. This device for steam generation is arranged upright in its longitudinal extension direction. A steam outlet can thus be on the top of the device, allowing steam to flow out easily. Preferably, the device for steam generation is flat and arranged with a flat side facing the treatment chamber, so that the installation depth is as low as possible.

These and further features are found in the description and in the drawings as well as in the claims, where the individual features can each be realized singly or severally in the form of sub-combinations in one embodiment of the invention, and in other fields, and can represent designs advantageous and protectable per se, for which protection is claimed here. The subdivision of the application into individual sections and sub-headings does not limit the statements made thereunder in their general validity.

### BRIEF DESCRIPTION OF THE DRAWINGS

Examples of the invention are shown schematically in the drawings and are explained in more detail in the following. The drawings show in:

FIG. 1 a schematic rear view of a steam oven in accordance with the invention as a water-bearing domestic appliance with steam generator,

FIG. 2 a steam generator in accordance with the invention in a front view,

FIG. 3 a sectional representation through the steam generator from FIG. 2,

FIG. 4 a plan view onto the heating element with heating conductor, temperature sensor and contact fields, and

FIG. 5 an oblique view onto a connection housing with insertable holding parts plus plug connection lugs therein.

### DETAILED DESCRIPTION OF THE EXAMPLES

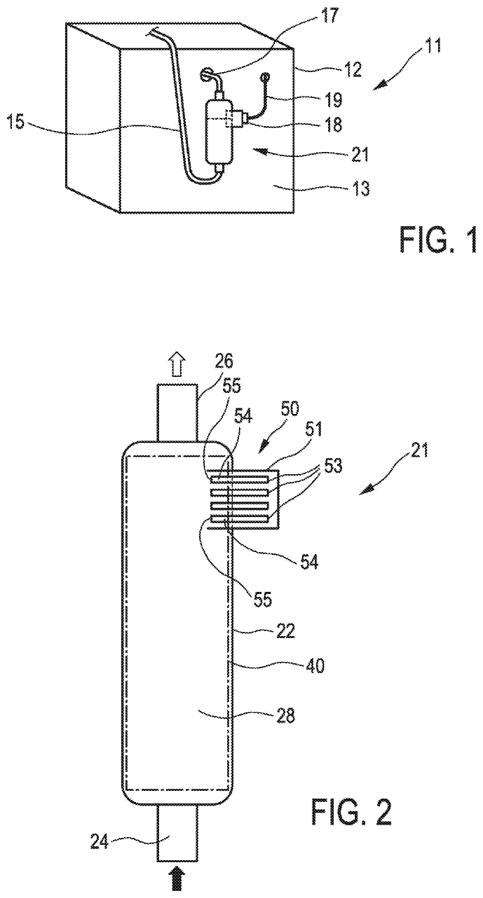

FIG. 1 shows a steam oven 11 in accordance with the invention as a water-bearing domestic appliance in a rear view and in very simplified form, in particular without the cover also advantageously provided, as is known per se from the prior art. The steam oven 11 has an appliance housing 12, in the interior of which a cooker muffle, not shown here but known from the prior art, is arranged as the treatment chamber mentioned at the outset. A steam generator 21 in accordance with the invention is arranged on a rear face 13 of the steam oven 11. It may advantageously also have a cover over it, protecting it from damage. The steam generator 21 has as a connection a water tube 15 routed from underneath. A steam pipe 17 leads out of the steam generator 21 at the top and into the treatment chamber mentioned. Thermal insulation is advantageously provided around the steam generator 21, or at least against the appliance housing 12 of the steam oven 11. The steam generator 21 is electrically connected by means of a plug 18 plus connection cable 19, advantageously to a control unit and/or power supply. This is explained in the following.

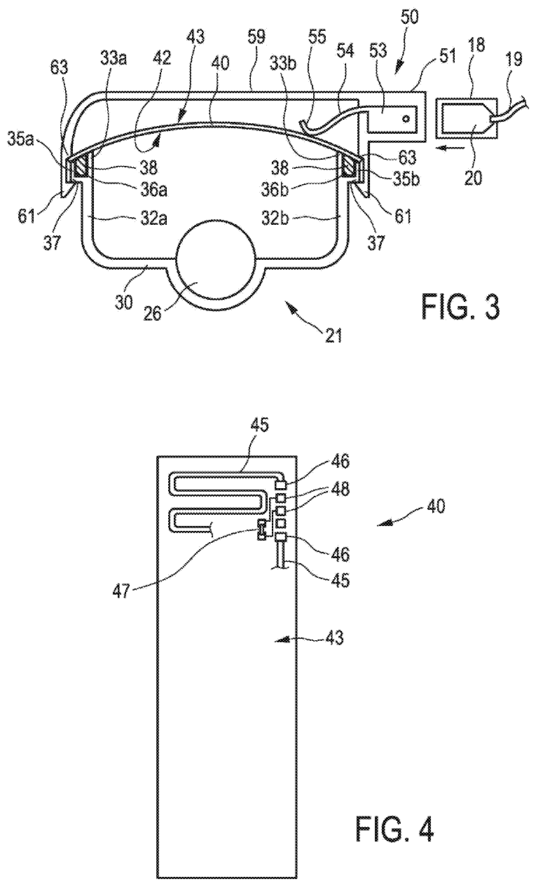

In the enlarged view in FIG. 2, it can be discerned that the steam generator 21 has a relatively flat and elongated device housing 22 that is also fitted upright in accordance with FIG. 1, cf. also FIG. 3. The steam generator 21 is about three times as long as it is wide, and in accordance with FIG. 3 it, or at least a heating chamber 28 formed in the interior, is approximately twice as wide as it is thick. It is thus evident that the steam generator 21, in its installed state on the steam oven 11 in accordance with FIG. 1, increases the installation depth towards the rear as little as possible. It may also be offset further to the side, for example to make room for a recirculated air fan beside a drive motor.

The device housing 22 of the steam generator 21 has at the bottom a water inlet 24 as a socket, to which the water tube 15 is connected in sealing manner. A water supply can be provided in the usual way, in particular controlled. A steam outlet 26 in socket form exits at the top of the steam generator 21. It is connected to the steam pipe 17, through which steam is released from the heating chamber 28 and passed into the treatment chamber of the steam oven 11.

The flat configuration of the steam generator 21 and above all of the heating chamber 28 can be seen from the sectional representation in FIG. 3. The latter is designed trough-like in the lower area, with a bottom 30 from which a left-hand side wall 32a and a right-hand side wall 32b extend upwards. The lateral or side walls 32a and 32b have at the top a trough rim 33a and 33b respectively. It runs all the way round and is preferably uninterrupted. An outer rim 35a and 35b, offset a few millimeters outwards, extends slightly outside this trough rim 33a and 33b respectively. Between them, a groove 36a and 36b is formed, into which a continuous seal 38 may be inserted. Alternatively, it may be injected. In the non-fitted state, the seal 38 protrudes upwards above the trough rims 33 and outer rims 35. This is advantageous for a dependable sealing function.

An elongated and curved heating element 40 is placed from above onto the trough-like lower part of the device housing 22, wherein it is in any event in sealing contact with the seal 38, and in particular sealing all round. It is possibly also in contact with one of the trough rims 33a or 33b or outer rims 35a or 35b. However, dependable sealing is always assured by means of the seal 38.

The heating element 40 is visibly curved, away from the bottom 30 of the heating chamber 28 and hence also away from the heating chamber 28 itself. On the one hand, this slightly increases its volume. On the other hand, the heating element 40 may be designed with more inherent stability. A sealing effect in the case of strong heating of the heating element 40, in its heating mode or during operation to generate steam, is better defined and hence better to control, since there is an even stronger curvature in the same direction during heating up due to the predetermined curvature. This heating element 40 is shown in a dot-dashed line in FIG. 2. It extends not only over almost the entire width but also over the entire height of the steam generator 21. As a result, the largest possible heating surface is achieved for the best possible steam generation.

The heating element 40 has a heating element carrier 41, advantageously made of metal. This heating element carrier 41 may be cut out of a pipe used as a kind of multiple blank, making manufacture simpler and more efficient. A water side 42 of the metallic heating element carrier may be bright metal, alternatively it may be coated for better heat input and/or improved corrosion resistance and/or improved anti-limescale properties. A heating side 43 facing upwards in FIG. 3 and shown in FIG. 4 carries the function elements of the heating element 40. This heating side 43 is advantageously provided with flat electrical insulation, for example a glass layer or a glass-like layer. At least one heating conductor 45 is attached thereon, here indicated in a meandering shape which is shown only in part. It may provide a generally identical surface output over the entire or over the maximum surface area of the heating side 43. Alternatively, it may be designed there for a greater heat output, where the water to be heated is located in the lower area of the steam generator 21, as indicated in FIG. 1 by a dotted line as the water level. The heating conductor 45 is provided with contact fields 46 at its ends, or it terminates there.

Furthermore, a discrete temperature sensor 47 is provided on the heating side 43, for example designed as an SMD component. The temperature sensor 47 is connected to two contact fields 48. Further and similar temperature sensors 47 may be provided, for example spread over an area in which there is always water, such that a water temperature in the interior of the heating chamber 28 can be measured as a result. A temperature sensor 47 arranged in the upper area can measure a steam temperature.

Furthermore, surface temperature monitoring, not shown in detail but known from the prior art, is advantageously provided, and can operate by means of a temperature-dependent leakage current or a temperature-dependent stray current. Reference is made in this connection to the known prior art, for example in the form of DE 10 2015 218 120 A1 or EP 3 840 528 A1. Such a temperature measuring system may also have its own contact fields.

As can be seen from FIG. 4, the contact fields 46 and 48 are attached along a line and at an equal distance to a right-hand outer rim of the heating element carrier 41. This serves to improve the electrical contacting. An electrical connection device 50, which has a connection housing 51, is provided for this. It is arranged on a housing cover 59 for the device housing 22 of the steam generator 21, or is shaped on in one piece. Several plug connection lugs 53 are firmly arranged inside the connection housing 51, from which extends an elongated and thin contact arm 54 at their rear ends. The latter is curved downwards and has a curved or hook-like contact end 55. This contact end 55 is in contact with one of the contact fields 46 or 48 by the downward-formed projection. It is thus possible to have electrical contacting on the heating element 40, and in particular both for high electrical output for heating operation and for low electrical outputs of temperature sensors or the like, by means of press-on contacts.

A plug 18 can be inserted into the connection housing 51 from the right in accordance with FIG. 3, and has plug connection sockets 20 connected to the connection cable 19 in its interior. A plug connection may be secured by additional connecting means such as catches or the like.

The lateral arrangement of the electrical connection or electrical connection device 50 plus plug 18 results in a very flat design on the rear of the steam oven 11. Furthermore, the plug-in process for the electrical connection can be performed safely and easily in this way. Repair and maintenance work are also possible in a convenient manner. The electrical connection does not increase the structural depth for the steam generator 21.

On the one hand it is possible to fit the plug connection lugs 53 plus contact arms 54 individually and firmly in the connection housing 51, for example by pressing or snapping them into place. Alternatively, they can be directly injected. The electrical contact to the contact fields 46 and 48 is made when the housing cover 59 is fastened. This fastening is achieved by means of the protruding engagement hooks 61 that snap into place over engaging projections 37 that are formed underneath the outer rims 35a and 35b. These engagement connections are advantageously provided all round, particularly advantageously even at the narrow ends of the steam generator 21 next to the water inlet 24 and to the steam outlet 26. As can be seen from FIG. 3 too, all-round press-on projections 63 are provided on the housing cover 59 slightly above the engagement hooks 61. They are located above the upper ends of the outer rims 35a and 35b, and press the outer area of the heating element 40 against the seal 38 and in the direction of these outer rims 35. This permits and ensures a firm, dependable and durably sealed arrangement of the heating element 40 on the heating chamber 28, whose cover it forms.

It can be readily seen from FIG. 3 how the electrical connection to the heating element 40 is achieved when the housing cover 59 plus electrical connection device 50 is pressed against the heating element 40 and the lower part of the device housing 22 of the steam generator 22. It is provided here that the heating element 40 is already arranged, possibly pre-fixed, on the lower part of the device housing 22. To do so, projections, possibly as small engagement hooks or the like, may be provided for example on the outer rims 35a and 35b, which come from below to grip over the top 43 of the heating element 40 and hold or pre-fix it in its required position. If the housing cover 59 is now firmly engaged on the lower part by the contact arms 54, these contact arms 54 are in contact with the contact fields 46 and 48 by their free contact ends 55.

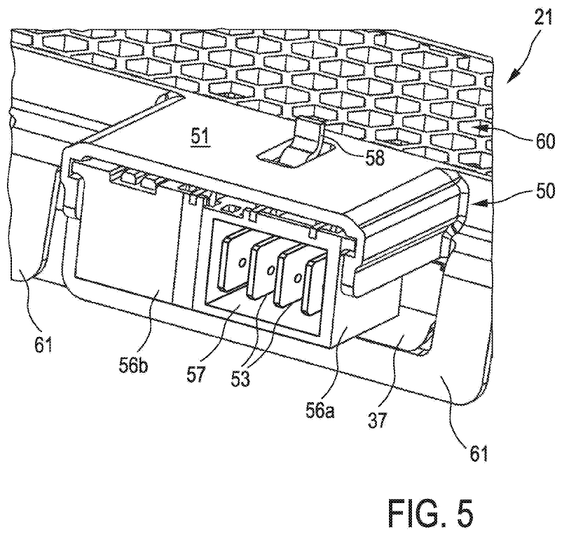

As an alternative, it may also be provided that the individual plug connection lugs 53 are not arranged permanently in the connection housing 51 before the housing cover 59 is snapped on. Groups of plug connection lugs, for example two groups, alternatively all the plug connection lugs, may be arranged in their own holding parts, which are then inserted from the outside into the connection housing 51 according to the insertion direction shown in FIG. 3. They may be fastened by catches or the like. Here too the contact ends 55 of the contact arms 54 come into contact with the contact fields 46 and 48 and thus make the electrical contact. This is shown in FIG. 5. The connection housing 51 has a right-hand holding part 56a with several plug connection lugs 53 in an interior 57a. It is inserted jointly, alternatively also separately, into the connection housing 51, with a left-hand holding part 56b plus further plug connection lugs, not shown here, using laterally protruding projections and receiving rails. The holding parts 56a and 56b are held in the connection housing 51 by an engagement device not shown in detail, from which a manually operable engaging arm 58 protrudes upwards. During this insertion of the holding parts 56, the free contact ends 55 of the protruding contact arms 54 again come into contact with the contact fields 46 and 48, as can be envisaged based on FIG. 3, thus resulting in electrical contacting.

It can also be seen from FIG. 5 that the upper side of the housing cover 59 is provided with a honeycomb structure 60 as the ventilation openings mentioned at the outset for the heating element 40. At the same time this gives the housing cover 59 a sufficient mechanical stability.

1. A steam generation device, having:
a device housing,
a heating chamber for water, said heating chamber having a water inlet for connection to a water supply, and a steam outlet,
a heating element on said heating chamber for heating up and evaporating water therein, wherein said heating element has a heating element carrier and heating conductors arranged on said heating element carrier,
wherein:
said heating chamber and said heating element are arranged in said device housing,
said heating element forms a wall of said heating chamber and is connected in sealing manner to other walls of said heating chamber,
said heating element carrier consists of metal,
said heating chamber is in one extension direction longer than it is wide and deep in both extension directions vertical thereto,
an electrical connection device for said steam generation device is provided laterally on said device housing on an elongated side of said heating chamber.

2. The device according to claim 1, wherein said heating element is designed as a thick-film heating element with thick-film heating conductors.

3. The device according to claim 1, wherein said connection device is designed as a plug connection device with plug connection lugs or plug connection sockets connected to said heating element electrically or structurally or mechanically.

4. The device according to claim 3, wherein said connection device protrudes laterally from said device housing.

5. The device according to claim 1, wherein said electrical contacting has contact fields connected to said heating conductors, wherein flexibly designed contact arms of the connection device are provided, and wherein said flexibly designed contact arms are pressed onto said contact fields.

6. The device according to claim 1, wherein said heating chamber and said device housing are flat and said electrical connection device protrudes from a narrow side of said device housing.

7. The device according to claim 1, wherein said heating element is curved in a channel shape away from said heating chamber such that a crest line of said curvature extends along an extension direction.

8. The device according to claim 7, wherein said curvature of said heating element corresponds to between 5% and 20% of said width of said heating element, and wherein said curvature has uniform rounding and said heating element is a casing section of 5% to 20% of an entire tube.

9. The device according to claim 1, wherein said device housing has an elongated trough for said heating chamber, wherein said water inlet and said steam outlet discharge into said elongated trough, wherein said trough has lateral trough walls, wherein on said lateral trough walls an all-round trough rim is provided, wherein said heating element is in sealing contact with said trough rim such that said trough and said heating element form said heating chamber and completely enclose it.

10. The device according to claim 6, wherein said heating chamber is flat and said water inlet and said steam outlet discharge into said heating chamber at said short flat sides.

11. The device according to claim 9, wherein a groove with a seal inserted therein extends around said trough rim, wherein said heating element is in all-round contact with said seal.

12. The device according to claim 11, wherein said device housing has a housing upper part being fastened to said trough, said trough forming a housing lower part, such that said housing upper part presses said heating element against said trough or against said seal.

13. The device according to claim 11, wherein said housing upper part has an all-round pressure rib, said pressure rib being opposite said trough rim or extending outside said trough rim over said seal.

14. The device according to claim 13, wherein said pressure rib extends all the way around and presses said heating element all the way around against said trough rim extending all the way around or against said seal.

15. The device according to claim 9, wherein said trough or a housing upper part has at one side, outside said all-round trough rim, supporting projections, wherein said heating element is with said supporting projections in contact with a lateral rim for fixing a position of said heating element in said device and on said trough.

16. The device according to claim 9, wherein a housing upper part is detachably fastened to said trough by means of a snap connection or a clip connection, wherein a fastening is provided running all round said heating chamber.

17. The device according to claim 1, wherein said electrical connection device is designed with a connection housing on a housing upper part of said device housing, wherein said connection housing is shaped onto said device housing in one piece.

18. The device according to claim 17, wherein said connection housing is open towards at least one side, wherein plug units are insertable into said connection housing from said side and are detachably fastenable therein, wherein said plug units are in electrical contact with said heating element by means of contact arms.

19. The device according to claim 18, wherein said plug units have plug connection lugs or plug connection sockets being held in a holding part consisting of plastic, wherein said contact arms protrude in an insertion direction.

20. The device according to claim 19, wherein said holding part is insertable into said connection housing and detachably fastenable therein by means of an engagement device.

21. The device according to claim 16, wherein said housing upper part extends at a short distance over said heating element, wherein said housing upper part has ventilation openings for ventilating or cooling said heating element.

22. The device according to claim 1, wherein a knitted fabric made of thin material is arranged in said heating chamber, at least in one area near to said steam outlet.

23. A water-bearing domestic appliance such as a steam baking oven or steam cooker, having an appliance housing and a treatment chamber for preparing cooked food by means of steam, wherein a device for steam generation according to claim 1 is arranged outside said treatment chamber, inside said appliance housing.

24. The water-bearing domestic appliance according to claim 23, wherein said device for steam generation is arranged upright in its longitudinal extension direction.

25. The water-bearing domestic appliance according to claim 24, wherein said device for steam generation is flat and arranged with a flat side facing said treatment chamber.
